(19) United States
(12) Patent Application Publication
(10) Pub. No.: US 2014/0230663 A1
(43) Pub. Date: Aug. 21, 2014

(54) Kitchenware Item with a Handle Which Works Electrically with a Removable Accessory

(71) Applicant: Jocelyn Bonnel, Vions (FR)

(72) Inventor: Jocelyn Bonnel, Vions (FR)

(73) Assignee: SEB S.A., Ecully (FR)

(21) Appl. No.: 14/131,720

(22) PCT Filed: Jul. 5, 2012
(86) PCT No.: PCT/FR2012/051578

§ 371 Date: Apr. 23, 2014

(30) Foreign Application Priority Data
Jul. 13, 2011 (FR) 1156365

(51) Int. Cl. A47J 36/16

(52) U.S. Cl. CPC A47J 36/165
USPC 99/348; 99/353

(57) ABSTRACT

Provided is a kitchenware item for cooking food, comprising a pan provided with a side wall, a handle comprising attachment means for attaching said handle to the side wall, and a removable accessory of the kitchenware item, said accessory or lid comprising an electromechanical device. The handle comprises an electrical energy source and the electrical energy source feeds the electromechanical device arranged on the accessory by means of an electrical circuit comprising electrical connection-disconnection means.

This invention concerns a kitchenware item designed to cook food, in particular, a frying pan, casserole, a sautéing pan, stewpot or pressure cooker, with a handle and removable accessory, in particular, a cover.

Document CH686338 covers a kitchenware item with a cover with a motor powered by a battery and an agitator rotated by the motor to mix the food. Such an arrangement mechanizes the shaking with the assistance of the motor and the battery to assist the user.

However, a kitchenware item with such a cover does not allow the user to easily monitor how the food is cooking. The weight of the cover is increased by the weight of the battery and, as a result, it is difficult to move. Further, the battery protrudes from the upper portion of the cover, which complicates storage of the kitchenware item with a cover.

The purpose of this invention is to eliminate the aforementioned inconveniences and offer a kitchenware item with a removable accessory which is ergonomically optimized to allow the user easily and safely handle it.

Another purpose of the invention is to offer a kitchenware item with a removable accessory which can be easily stored.

Another purpose of the invention is offer a kitchenware item with a removable accessory with a simple design which is easy to use.

These purposes are achieved with a kitchenware item designed to cook food with a cap with a lateral face, a handle including an attachment mechanism to attach it to the lateral face and a removable accessory for the kitchenware item which includes an electromechanical mechanism, wherein said handle includes an electrical energy source and the electrical energy source powers the electromechanical mechanism located on the accessory using an electrical circuit with an electric mechanism to connect and disconnect.

Removable accessory is understood to mean an accessory that the user may easily remove from or replace on the kitchenware item when cooking the food without using any tools.

Such an arrangement creates a kitchenware item with a removable accessory which offers the user mechanized functions using the electromechanical mechanism powered by the energy source. The heavy, bulky component, which mechanizes the functions, i.e., the energy source, is located in the handle. This does not increase the accessory's weight, does not protrude and, therefore, keeps the accessory easy to use and store. Further, the positioning of the energy source in the handle improves ergonomics by shifting the center of gravity toward the handle held by the user.

Advantageously, the electrical connection-disconnection mechanism is located partly on the handle and partly on the accessory to allow the user to remove or replace the accessory on the kitchenware item (1).

Preferably, the accessory rests on the cap.

Advantageously, the electrical connection-disconnection mechanism includes electrical contact terminals and the electrical contact surfaces where said contact surfaces come into contact with the contact terminals when the handle and the accessory are attached.

This arrangement results in a connection-disconnection mechanism which is simple and easy to use.

Preferably, the electrical contact surfaces are pushed against the terminals by the elastic recall mechanisms to limit contact resistance to less than 100 mOmh, and preferably to less than 10 mOhm.

This arrangement avoids contact heating when the electromechanical mechanism is powered by the electrical energy source and thereby creates a reliable and sure electrical connection. Further, this arrangement removes any fouling which might be generated between the contact surfaces due to the force generated on the contacts by the recall mechanisms.

Advantageously, each electrical contact surface and each electrical contact terminal has a cross section of at least 0.75 mm² to resist current which exceeds 0.5 A, preferably 3 A.

This arrangement creates an electrical connection which passes strong current and therefore creates a powerful electromechanical mechanism, in particular, with a trigger.

Preferably, the handle includes a hollow grasping body and the electrical energy source is a battery, housed in said body.

This arrangement allows a rechargeable energy source which is sufficiently independent for the mechanization of the planned functions.

Advantageously, the removable accessory is a cover designed to cover the cap.

The cover covers the kitchenware item to form, with the cap, a cooking chamber which is raised above the food. The cover and its electromechanical mechanism are, therefore, a worthwhile accessory to provide the user with the mechanized functions.

Preferably, the electromechanical mechanism located on the cover has an electrical motor.

This arrangement mechanizes the functions supported on the cover in a way which is easy to use.

Advantageously, the cover contains a food shaking or grinding mechanism located in the cap, where said shaking or grinding mechanism is powered by the electrical motor.

This arrangement mechanizes the shaking or grinding of food located in the cap.

Preferably, the shaking mechanism includes a mixing paddle.

Advantageously, the cover contains a mechanism to cool said cover, with said cooling mechanism powered by the electrical motor.

This arrangement mechanizes the position cooling of the cover. The cooling of the cover allows the steam generated by the food in the cap during the cooking to be condensed. The condensed water falls back on the food, thereby ensuring that it doesn't dry out.

Preferably, the cooling mechanism includes a ventilation helix.

This arrangement results in a cooling mechanism which is simple and easy to use.

Advantageously, the removable accessory is a mechanism which lights the interior of the cap.

This arrangement very effectively lights the food while it is cooking in the cap.

Advantageously, the handle attachment mechanism can be detached so that said handle can be attached to and removed from the lateral face.

This arrangement improves storage of the kitchenware item and also facilitates battery recharging since the handle can be placed on a recharging base once removed from the kitchenware item.

Preferably, the kitchenware item is a frying pan, casserole, sautéing pan or stewpot.

Preferably, the kitchenware item is a pressure cooker with a waterproof cooking chamber within which food under steam pressure is cooked.

The invention will be best understood by reviewing the methods of implementation, which are in no any way limitative, shown in the attached diagrams in which:

Diagram 1 shows a schematic cut-away view of a kitchenware item and cover in accordance with one method of implementation of the invention.

Diagram 2 shows a schematic perspective view of the handle and cover (partial view) of the kitchenware item shown in Diagram 1.

Diagram 3 shows a partial schematic cut-away view of an electrical contact surface of the handle along line III-III shown in Diagram 2.

Diagram 4 shows a partial schematic cut-away view of the electrical contact surface of the handle shown in Diagram 3 with the cover on the kitchenware item.

Diagram 5 shows a schematic cut-away view of a kitchenware item and cover in another method of implementation of the invention.

Diagram 6 shows a schematic cut-away view of a removable handle of the kitchenware item in accordance with one method of implementation of the invention.

Diagram 7 shows a perspective view of the removable handle shown in Diagram 6.

Diagram 8 shows a schematic cut-away view of a kitchenware item and lighting mechanism in another method of implementation of the invention.

In accordance with one initial method of implementation shown in Diagrams 1 and 2, kitchenware item 1 includes cap 2 with bottom 7 and lateral face 3, where cover 4 is designed to cover cap 2 and handle 5. Handle 5 is attached to lateral face 3 by the attachment mechanism (not shown in the diagrams). The attachment mechanism may include a gudgeon attached to the cap which works with a screw located in an opening in the handle.

Handle 5 is elongated and extends out from lateral face 3 in longitudinal direction X. Handle 5 includes grasping body 50 in which electrical energy source 6 is housed.

Lateral face 3 includes upper edge 15 which may be curved to the exterior to form a pouring spout on which cover 4 rests. Cover 4 contains exterior ledge 10 which extends radially beyond upper edge 15 and which has fold 11 which forms a basically horizontal face. Exterior ledge 10 of cover 4 rests on upper edge 15 of cap 2.

Cover 4 contains an electromechanical mechanism including electrical motor 21 controlled by the control mechanism and powered by energy source 6 through an electrical circuit. The electrical circuit contains initial section 24 located in handle 5 and second section 25 located in cover 4.

Initial section 24 of the electrical circuit contains electrical contacts surfaces 26 connected to energy source 6 by two connection wires 27. Surfaces 26 are generally cylindrical and are located to be able to move perpendicularly to longitudinal direction X on upper face 51 of handle 5.

Second section 25 of the electrical circuit contains contact terminals 28 connected to a command circuit included in the control mechanism by through two connection paths 29 which are silk screened onto the cover.

In one variation of implementation not shown, contact terminals 28 are connected to the command circuit by two connection wires. The connection wires and the contact terminals are located in a hood attached to the cover. Advantageously, the hood contains protuberances near the contact terminals to allow cover 4 to be positioned on handle 5.

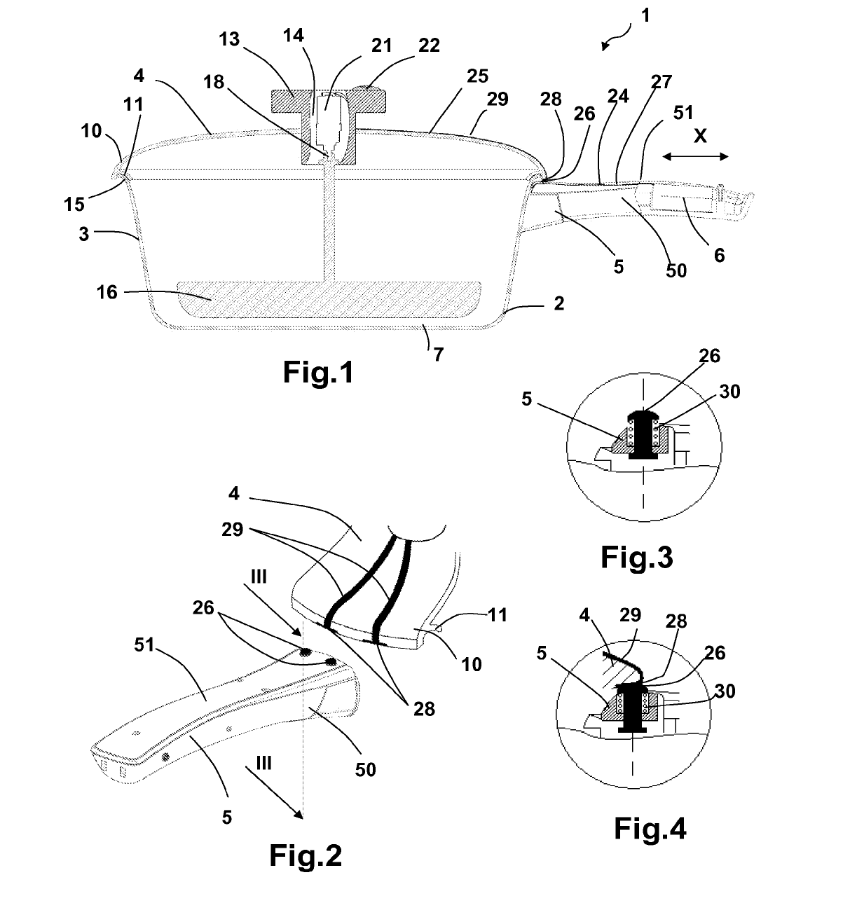

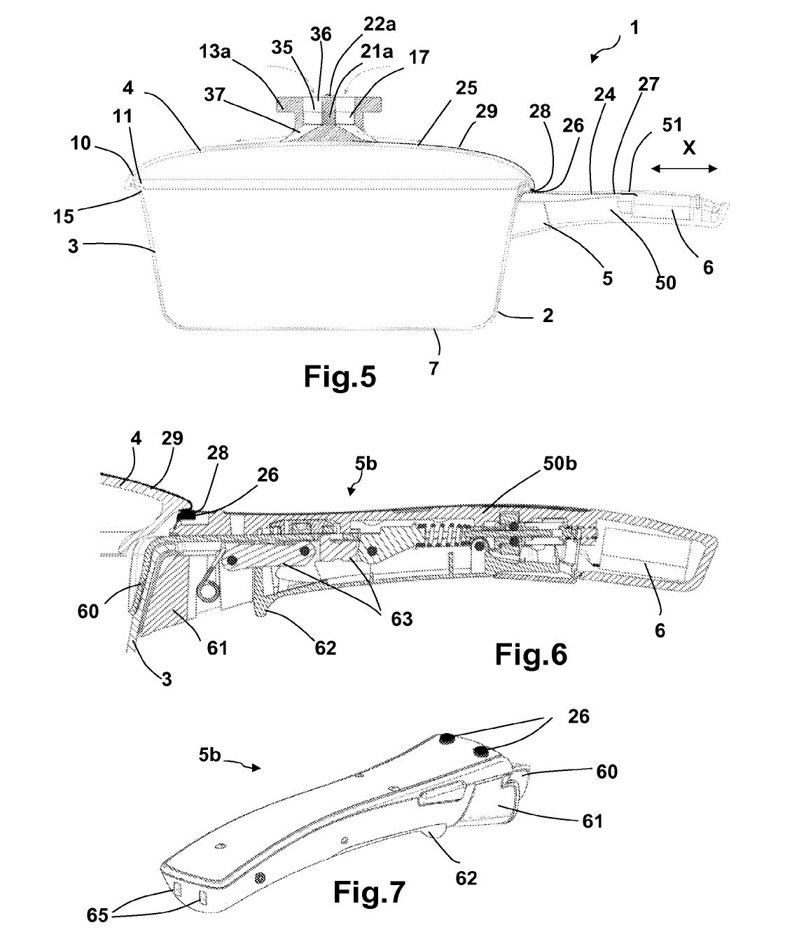

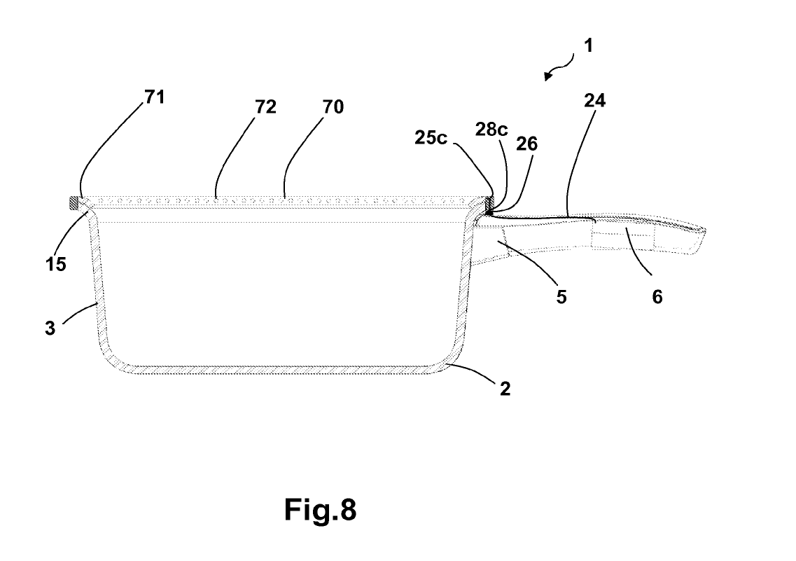

Contact terminals 28 are designed to be connected to contact surfaces 26 when cover 4 rests on cap 2. Surfaces 26 move between a rest position in which cover 4 is not present, in which they project above upper face 51 of handle 5 due to the action of springs 30 (FIG. 3) and a work position in which they are pushed against the interior of handle 5 by contact terminals 28 under the weight of cover 4 against the recall force of springs 30 to limit contact resistance to less than 10 m0mhs (FIG. 4). In this method of implementation, surfaces 26 and terminals 28 are connected vertically, perpendicular to bottom 7 of cap 2.

Each electrical contact surface 26 and each electrical contact terminal 28 has a cross section of at least 0.75 mm to resist current which exceeds 0.5 A, and preferably 3 A.

In another method of implementation not shown, the second section of the electrical circuit includes at least one concave terminal designed to accommodate an extension of one of the electrical contact surfaces on the handle. The concave terminal is formed by a boss in the cover ledge. The head of the surface is convex and complements the shape of the concave terminal. The concave terminals on the surfaces have convex heads to maximize electrical contact and correct for slight misalignment of the cover with the handle.

Electrical energy source 6 may include a rechargeable electrical energy source (a large battery or super capacitor) or one or more small batteries. For example, the large battery could provide 3.6 volts and 780 mA/hour. Electrical energy source 6 may be removed and be recharged in a charger outside kitchenware item 1.

As shown in Diagram 1, cover 4 contains handle 13 located in the center. Handle 13 includes cavity 14 in which electrical motor 21 is located and controlled by the control mechanism. The control mechanism includes control button 22 which can be accessed from the exterior of handle 13 of cover 4 and an electronic circuit (not shown) connected to control button 22 and electrical motor 21. Control button 22 is located in the upper portion of handle 13. When the user presses control button 22, a signal is transmitted to the electronic circuit which orders electrical motor 21 to rotate.

Paddle 16 is arranged on exit shaft 18 of electrical motor 21. The rotation of electrical motor 21 drives paddle 16 to mix food (for example, purée, fried vegetable or soup) located at the bottom of the cap. Paddle 16 could be attached to exit shaft 18 of electrical motor 21 using the attachment mechanism to allow the user to remove the paddle to, for example, facilitate washing. The paddle may be soft and folded in the cover. The paddle may have various forms depending on the type of preparation. For example, the paddle could contain a vertical face with a fold on the lower section to return the food during mixing or the paddles could have a perforated face for sauces and soups.

In one completion variation, the cover contains a mechanism to grind the food. The grinding mechanism may include a perforated flat area or partial area. The flat area, which is positioned horizontally above the food, is driven by a vertical movement combined with a rotation of several degrees upon each vertical movement. In this method of implementation, the cover contains a screw mechanism on the cap.

Preferably, electrical motor 21 includes a speed reduction gear. For example, the rotation speed of the motor is designed to rotate the paddle at approximately fifteen rotations per minute. Paddle rotation speed may be adjustable.

In operation, the user places the food to be cooked in kitchenware item 1. To cook it, he places kitchenware item 1 on a heat source. He grasps cover 4 and positions exterior ledge 10 on upper edge 15 by aligning terminals 28 on surfaces 26 by moving it vertically. Due to the weight of cover 4, surfaces 26 are pushed by terminals 28 to the interior of handle 5, against the recall force of springs 30. Thus, the electrical circuit connecting electrical energy source 6 to electrical motor 21 is closed. When the user wishes, he activates shaking paddle 16 by pressing control button 22. The user may raise cover 4 during cooking, which causes terminals 28 and surfaces 26 to separate. The electrical circuit is thereby opened and paddle 16 stops shaking.

In accordance with the method of implementation shown in Diagram 5, cover 4 contains handle 13a including electrical motor 21 which rotates ventilation helix 17. Handle 13a contains central channel 35 in which electrical motor 21 and helix 17 are located to circulate air between entrance 36 located in the upper section of handle 13a and exit openings 37 circulate air generally tangentially to cover 4. Electrical motor 21a is controlled by the control mechanism with control button 22a.

In one variation shown in Diagrams 6 and 7, handle 5b contains a removable attachment mechanism to attach said handle 5b to and remove it from lateral face 3. The attachment mechanism includes two jaws 60 and 61 which form a pincer in which jaws 60 move relative to other jaws 61 between an open and closed position in which two jaws 60 and 61 pinch lateral face 3 of the kitchenware item. The attachment mechanism also includes a movement mechanism designed to move pinching jaws 60 and 61 between an open and closed position. The movement mechanism includes lever 62 which pivots on handle 5b between a position inside and outside handle 5b. A set of rods 63 is designed to move mobile jaws 60 when lever 62 is pivoted manually by the user. Such a removable handle is described in more detail in document FR 2 898 031.

Handle 5b contains grasp body 50b in which electrical energy source 6 is housed and linked to connection surfaces 26. If a rechargeable electrical energy source is used, handle 5b includes an electrical connection mechanism which is accessible from the exterior of the handle to recharge rechargeable energy source 6. The electrical connection mechanism may include two electrical connection terminals 65 connected to rechargeable electrical energy source 6. Electrical connection terminals 65 may be connected and disconnected using two electrical connection terminals on a recharging base to recharge electrical energy source 6. Electrical connection terminals 65 are located on the back of the handle.

In another method of implementation shown in Diagram 8, kitchenware item 1 includes removable lighting mechanism 70 resting on upper edge 15 of lateral face 3. Lighting mechanism 70 contains framework 71 supporting an electromechanical mechanism with light-emitting diodes (LED) 72 powered by energy source 6 through an electrical circuit. The electrical circuit contains initial section 24 in handle 5 and second section 25c in lighting mechanism 70.

Initial section 24 of the electrical circuit contains electrical contact surfaces 26 connected to energy source 6. Second section 25c of the electrical circuit contains contact terminals 28c linked to light-emitting diodes 72.

In one variation, lighting mechanism 70 contain a mechanism to control light-emitting diodes 72, for example, in the form of a switch on framework 71 or handle 5.

Of course, the invention is not in any manner limited to the methods of implementation described and shown which have been provided only as examples. Modifications are possible, in particular, from the point of view of creating other items or replacement with equivalent techniques, without, however, falling outside the scope of protection of the invention.

Accordingly, in one completion variation, the cover supporting the electromechanical mechanism may be replaced by a support item, for example, a tripod.

1. A kitchenware item designed to cook food with a pan with a lateral face, a handle with an attachment mechanism to attach it to the lateral face and a removable accessory of kitchenware item, where said accessory is separate from the handle and includes an electromechanical mechanism, wherein said handle contains an electrical energy source, wherein the electrical energy source powers the electromechanical mechanism located on the accessory through an electrical circuit with an electrical connection-disconnection mechanism.

2. The kitchenware item in accordance with claim 1, wherein the electrical connection-disconnection mechanism is partly located on the handle and partly on the accessory to allow the user to remove or replace the accessory on the kitchenware item.

3. The kitchenware item in accordance with claim 1, wherein the accessory rests on the pan.

4. The kitchenware item in accordance with claim 1, wherein the electrical connection-disconnection mechanism includes electrical contact terminals and electrical contact surfaces, where said contact surfaces come into contact with the contact terminals when the handle and the accessory are attached.

5. The kitchenware item in accordance with claim 4, wherein the electrical contact surfaces are pushed by elastic recall mechanisms against the contact terminals to limit the contact resistance to less than 100 mOmh.

6. The kitchenware item in accordance with claim 1, wherein the handle includes a hollow grasping body and the electrical energy source is a battery, housed in said hollow grasping body.

7. The kitchenware item in accordance with claim 1, wherein the removable accessory is a cover designed to cover the pan.

8. The kitchenware item in accordance with one claim 1, wherein the electromechanical mechanism located on the cover contains an electrical motor.

9. The kitchenware item in accordance with claim 8, wherein the cover contains a food shaking or grinding mechanism in the pan, where said shaking or grinding mechanism is driven by the electrical motor.

10. The kitchenware item in accordance with claim 9, wherein the shaking mechanism includes a mixing paddle.

11. The kitchenware item in accordance with claim 8, wherein the cover contains a cooling mechanism for said cover, where said cooling mechanism is power the electrical motor.

12. The kitchenware item in accordance with claim 11, wherein the cooling mechanism includes a ventilation helix.

13. The kitchenware item in accordance claim 1, wherein the removable accessory is a lighting mechanism -of the interior of the pan.

14. The kitchenware item (1) in accordance with claim 1, wherein the handle attachment mechanism can be removed to attach said handle to, and remove it from, the lateral face.

15. The kitchenware item in accordance with claim 1, wherein the item is one of a frying pan, casserole, sautéing pan, stewpot or pressure cooker which form a watertight cooking chamber, within which food is cooked under steam pressure.

16. The kitchenware item in accordance with claim 4, wherein the electrical contact surfaces are pushed by elastic recall mechanisms against the contact terminals to limit the contact resistance to less than 10 mOhm.
